(19) United States
(12) Patent Application Publication
(10) Pub. No.: US 2001/0051460 A1
(43) Pub. Date: Dec. 13, 2001

(54) Socket for automotive vehicles

(76) Inventors: Hidetoshi Ota, Tokyo (JP); Noboru Sato, Tokyo (JP); Takashi Sakamaki, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/876,991

(22) Filed: Jun. 11, 2001

(30) Foreign Application Priority Data
Jun. 12, 2000 (JP) 2000-175585

(51) Int. Cl. H02B 1/01

(52) U.S. Cl. 439/558

(57) ABSTRACT

A socket for automotive vehicles is provided, in which the number of components and the assembling man-hour is small, and thus the cost is low. A vehicle socket is electrically connected to a power supply with a plug of an appliance for automotive vehicles. The socket is formed of a resinous molded body of near cylindrical shape comprising a flange along an outer periphery of an opening in which the plug is inserted, and terminals molded on the bottom surface by insert molding.

### BACKGROUND OF THE INVENTION

1. Field of the Invention

The present invention relates to a socket for automotive vehicles to be exclusively used for appliances having a plug for connecting to the cigarette lighter socket in the automotive vehicle.

2. Description of the Related Art

Hitherto, the socket for cigarette lighters is used for the provided appliances to be use in the automotive vehicle. However, a bimetal to which the heater cap of the plug of the cigarette lighter is fitted is projected from the insulator on the inner wall in such a socket. When a plug of the appliance for automotive vehicle other than the plug of the cigarette lighter is inserted into the socket for cigarette lighters, the plug resists engaging the bimetal described above, whereby the bimetal may disadvantageously be deformed or the plug of the appliance for automotive vehicles may be damaged.

As a socket devised to solve the problem described above, for example, there is a device disclosed in Japanese Utility Model Publication No.22552/1985. This socket is provided with a resinous mounting base on the side of the opening of the metal body, and with an insulating board having a terminal fitting and an insulating base having a terminal on the side of the bottom surface of the body. The body is formed of a conductive body almost in the shape of a can, and comprises a resilient strip to be brought into electrical contact with the plug and the bottom portion to be brought into electrical contact with the earth terminal to construct a part of an electric circuit. The bottom surface of the body is fixed with the terminal fitting, the insulating board, the insulating base, the earth terminal, and the plus terminal by caulking the terminal fitting.

However, since the socket described above is formed of a metal body comprising a resinous mounting base provided on the side of the opening and an insulating board having a terminal fitting and an insulating base having a terminal provided on the side of the bottom surface, the number of the components are large, and thus the number of steps to assemble, thereby increasing the cost.

The socket of the related art has only two holes; an opening and a notch formed by cutting three sides of the square in the vicinity of the opening; and the bottom surface of the socket has no hole thereon. Therefore, there are problems in that the heat releasing effect in case of abnormal heat generation in the plug is small, and in that when the water entered therein, it cannot be discharged easily. In addition, when the body is heated, the heat is easily transmitted to the whole part of the metallic body, and thus the collar of the body outside of the flange may cause burn injury when the body gets into touch with it.

Since the size of the socket and the plug for cigarette lighters varies conventionally, there is recognized problem in that the plug may fall off the socket due to the vibration of the vehicle body when the size of the plug does not conform to the size of the socket.

### SUMMARY OF THE INVENTION

Accordingly, the object of the present invention is to provide a socket for automotive vehicles in which the number of the parts and the number of steps for assembly are small and the cost is low.

The present invention is directed to solve the problems of the related art described thus far, and the invention according to a first aspect is a socket for automotive vehicles for receiving the plug of the appliance for automotive vehicles to electrically connect to the power supply, comprising a near cylindrical resinous molded body having a flange formed along the outer periphery of the opening to which the plug is inserted, and terminals formed on the bottom surface by insert molding.

The invention according to a second aspect is an invention according to the first aspect, wherein the socket is provided with a conductive inner case to be brought into contact with resilient electrodes of the plug on the inner wall surface of the socket, and a bimetal to be brought into contact with the terminal in conduction with the inner case in case of abnormal heat generation is electrically connected to the terminal disposed on the bottom surface thereof.

The invention according to a third aspect is an invention according to the second aspect, wherein the inner case comprises a cylindrical portion formed on the inner wall surface of the socket, the terminal projected from the cylindrical portion, and the earth terminal all formed of a piece of conductive metal plate.

The invention according to a fourth aspect is an invention according to the third aspect, wherein the terminal and the earth terminal are formed by tucking down from the inner wall surface of the socket to form recesses for disposing the resin material forming the socket.

The invention according to a fifth aspect is an invention according to the second, third or fourth aspect, wherein the terminal comprises a power supply connecting portion projecting outwardly from the bottom surface of the socket for being connected with the power supply, and a connecting projection being in contact with the electrode portion of the plug and exposed from the center of the bottom surface, and wherein the bimetal is electrically connected to the terminal at the portion surrounding the connecting projection.

The invention according to a sixth aspect is an invention according to the fifth aspect, wherein the terminal includes a supporting strip for positioning thereof projecting outwardly from the portion surrounding the connecting projection to be supported by the metal mold when the socket is molded by the metal mold.

The invention according to a seventh aspect is an invention according to the sixth aspect, wherein the bottom surface of the socket is formed of insertion holes adjacent to the supporting strips or the connecting projection.

The invention according to an eighth aspect is an invention according to the fifth aspect, wherein the bimetal is formed into the shape of near L-shape and formed with a through hole for fitting the shoulder formed around the connecting projection therein on one end and provided with a temperature deformation portion inserted into the hollow portion formed on the bottom surface of the socket so as to be opposed to the terminal in conduction with the inner case on the other side.

The invention according to a ninth aspect is an invention according to the first, second, third, fourth, fifth, sixth, seventh or eighth aspect, wherein the socket includes a projection formed of an insulating resin on the bottom surface.

The invention according to a tenth aspect is an invention according to the first or second aspect, wherein the socket is formed with a resilient arresting strips on the outer periphery thereof to which the inner edge of the mounting hole on the vehicle-side member abuts, and a threaded portion with which the nut for screwing the socket to the mounting hole on the vehicle-side member engages.

The invention according to an eleventh aspect is an invention according to the first, second, third, fourth or tenth aspect, wherein the socket is formed in the opening with a plug holding portion to which the resilient supporting portions provided on the outer periphery of the plug engages.

The invention according to a twelfth aspect is an invention according to the eleventh aspect, wherein the socket is provided with a mark on the flange for registering the resilient supporting portion of the plug and the plug holding portion.

### BRIEF DESCRIPTION OF THE DRAWINGS

FIG. 1 is a longitudinal central cross-section of an embodiment of the present invention showing a state in which a lid is opened;

FIG. 2 is a bottom view of an embodiment of the present invention showing a state in which the lid is opened;

FIG. 3 is a lateral central cross-section of an embodiment of the present invention showing a state in which the lid is opened;

FIG. 4 is a front view of an embodiment of the present invention showing a state in which the lid is removed;

FIG. 5 is a back view of the embodiment of the present invention showing a state in which the lid is removed;

FIG. 6 is a front view of the embodiment of the present invention showing a state in which the lid is removed;

FIG. 7 is a cross sectional view taken along the line X-X of FIG. 1;

FIG. 8 is a perspective view of the inner case showing an embodiment of the present invention; and

FIG. 9 is across-sectional view showing a principal portion of another embodiment of the present invention.

### DESCRIPTION OF THE PREFERRED EMBODIMENTS

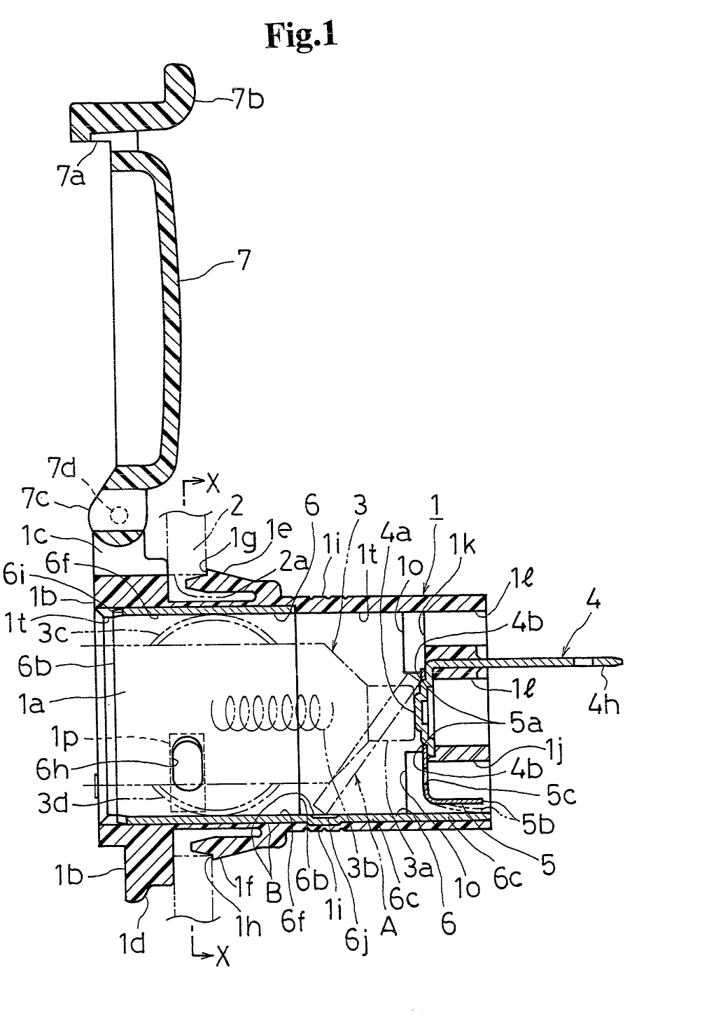

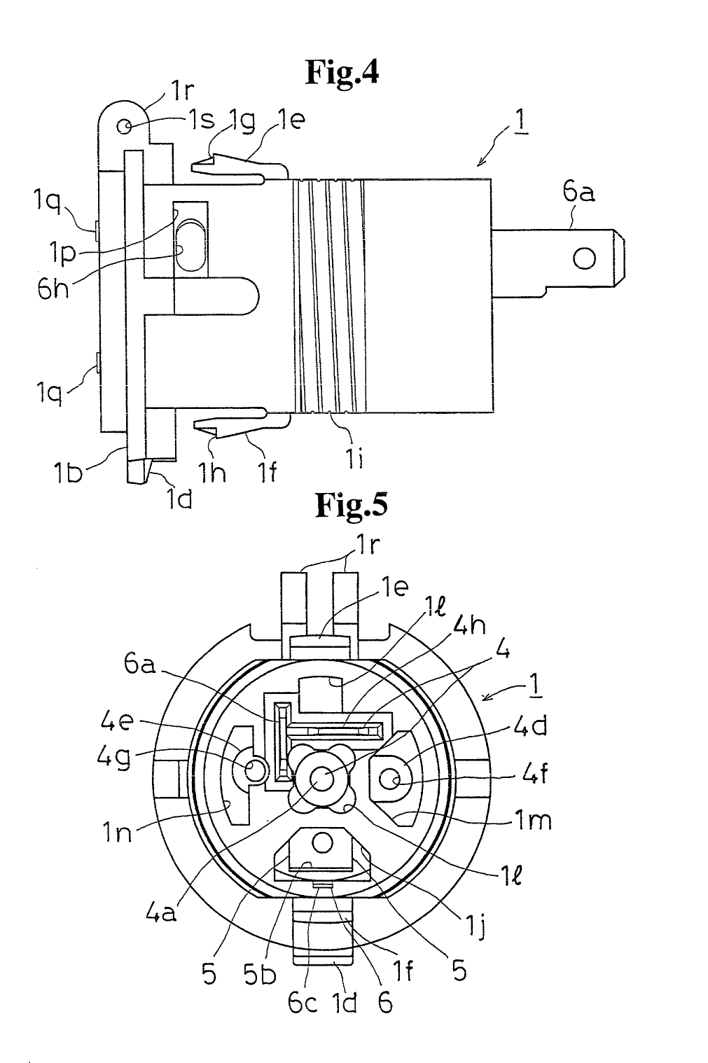

Referring now to FIG. 1 to FIG. 9, an embodiment of the present invention will be described.

Reference numeral 1 designates a resinous socket for appliances to be used in the automotive vehicle, which is almost the cylindrical shape. The socket 1 is inserted into the mounting hole 2a on the vehicle-side member 2, for example, the sidewall or the like in the interior of the cabin such as the instrument panel, the console box, the door, or the luggage room or the like.

The socket 1 is formed of a heat-resistance insulating resin such as nylon containing for example glass component by approximately 30[%]. The socket 1 is an electrically connecting equipment formed in the shape of the cylinder with a bottom, and installed in the opening 1a so as to be freely closed by a lid 7. On the outer periphery of the opening 1a, there is formed a flange 1b . The flange 1b is formed with a hinge portion 1c for holding the lid 7 so as to rotate freely, a locking portion 1d provided at the position opposing to the hinge portion 1c.

In the vicinity of the flange 1b, as shown in FIG. 1, resilient arresting strips 1e, 1f to which the mounting hole 2a of the vehicle-side member 2 is press-fitted are formed, and the shoulders 1g, 1h on the resilient arresting strips 1e, 1f and the inner surface of the flange 1b fix the socket 1 to the vehicle-side member 2 through one-touch operation. In the case where it is installed to the mounting hole 2a formed on the relatively thin member such as an instrument panel or a console box, as shown in FIG. 1, the resilient arresting strips 1e, 1f is used to install it to the vehicle-side member 2.

In the case where the socket 1 is mounted to the luggage room of which the thickness of the vehicle-side member 2 is thick member, as shown in FIG. 3, it is screwed by engaging a nut 8 to the threaded portion 1i formed on the outer periphery of the socket 1.

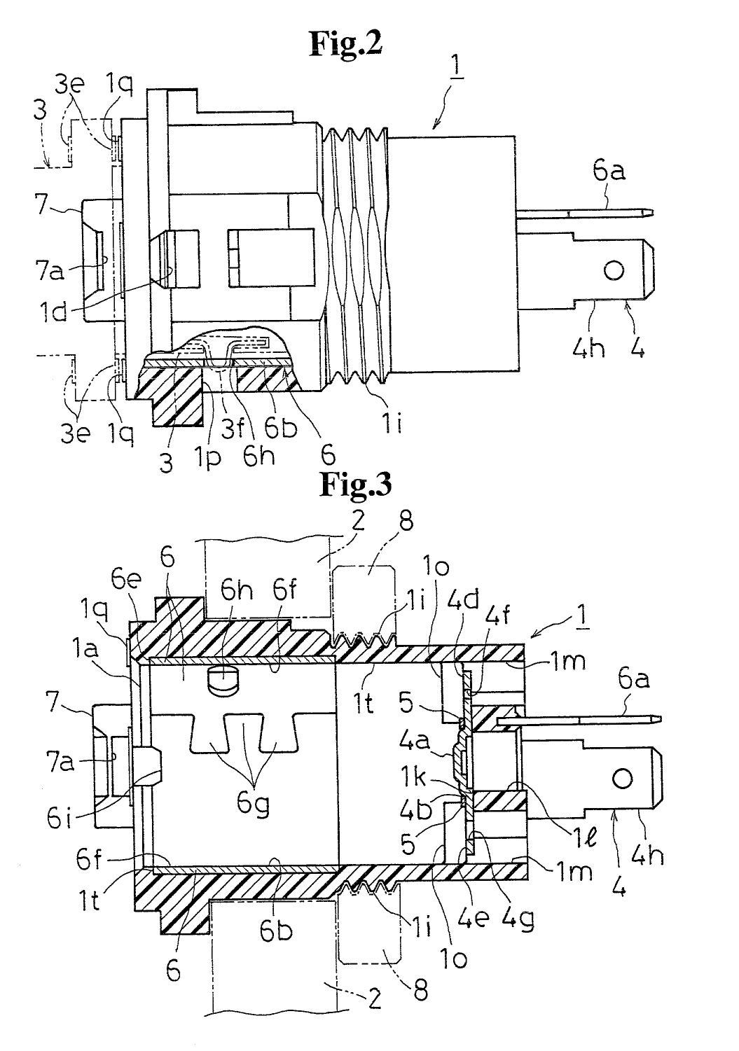

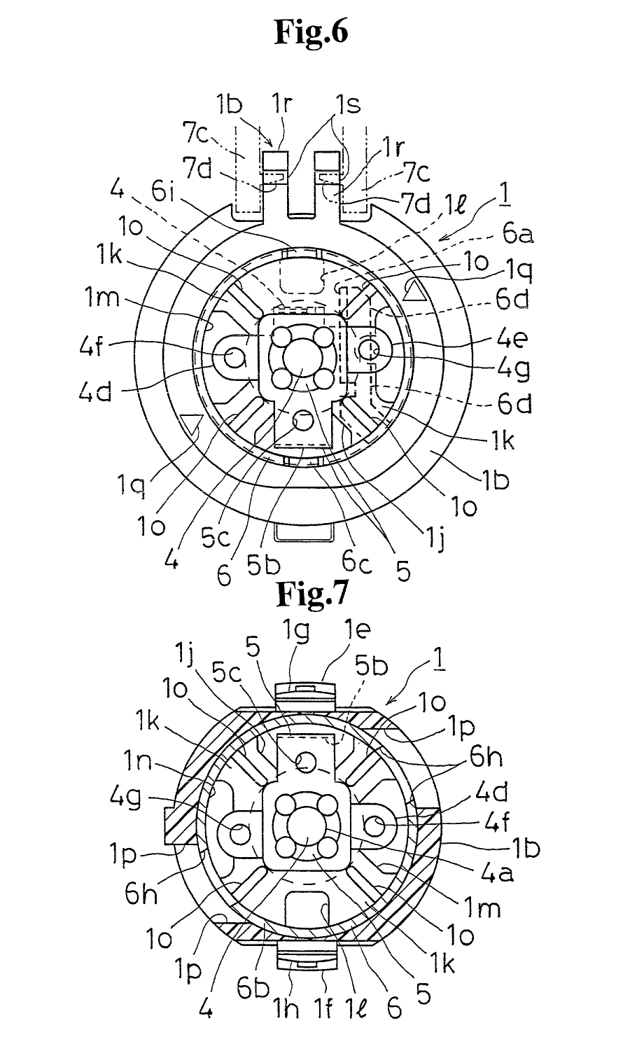

On the front side of the flange 1b, as shown in FIG. 6, there is a triangle mark 1q representing the position where the plug holding portion 6h formed in the socket 1 resides. The mark 1q is, as shown in FIG. 2, a remarque to represent the position that the resilient supporting portion 3f that is provided on the plug 3 is fitted to the plug holding portion 6h when the plug 3 is inserted into the socket 1 with the mark 3e provided on the plug 3 registered therewith.

When the plug 3 is inserted into the socket 1 with the mark 3e of the plug 3 registered with the mark 1q, the resilient supporting portion 3f is fitted to the plug holding portion 6h, thereby preventing the plug 3 is from being fallen off the socket 1.

The flange 1b is formed with a hinge portion 1c for rotatably mounting the lid 7 to close the opening 1a, for example, on the upper side. The lid 7 mounted on the hinge portion 1c can be maintained in a state of closing the opening 1a with the claw 7a hooked to the locking portion 1d by holding the grip portion 7b with a hand and pressing the claw 7a toward the locking portion 1d.

The hinge portion 1c is formed by engaging the shaft portions 7d, 7d, formed on the projecting strips 7c, 7c into the shaft holding holes 1s formed on the tongue strips 1r shown in FIG. 6. Since the lid 7 is formed entirely of resin, and the projecting strips 7c, 7c have resiliency, it can be mounted to the hinge portion 1c of the socket 1 through one-touch operation by press fitting the projecting strips 7c, 7c to the outsides of the tongue strips 1r, 1r.

The plug holding portion 6h is constructed of a continued hole formed on the inserting space 1p of the socket 1 and the cylinder portion 6b of the inner case 6. The resilient supporting portion 3f of the plug 3 is, as shown by a phantom line in FIG. 2, constructed of a resilient projection formed on the outer wall of the plug 3 to be inserted into the socket 1. The resilient supporting portion 3f is a member that is formed by incurvating the leaf spring to be fitted to the plug holding portion 6h so as to projects from the plug 3 for rising and setting movement, and constructed of projections such as the resilient electrode strips 3c, 3d described above.

The resilient supporting portion 3f may be a resilient supporting portion 3h formed of a projection such as a pin that is urged by a spring member 3g constituting the resilient electrode portions 3c, 3d and fitted to the plug holding portion 6h as shown in FIG. 9, and the configuration is not specifically limited. The resilient supporting portion 3h is formed with a flange 3i at the proximal end to be urged by the spring member 3g, and the tip portion thereof is formed in a semi-spherical shape so that it can easily be fitted to and released from the plug holding portion 6h.

While the plug holding portion 6h to which the resilient supporting portions 3f, 3h are fitted is described to be formed on the cylindrical portion 6b of the inner case 6 as shown in FIG. 1, FIG. 3, and FIG. 9, it can also be disposed so as to be fitted directly to the insertion space 1p of the socket 1. The resilient supporting portion 3f may also be used as the resilient electrodes 3c, 3d.

The socket 1 comprises a power supply terminal 4 at the bottom surface 1k, a bimetal 5 electrically conducted to the power supply terminal 4, and an earth terminal 6a of the inner case 6 formed by insert molding. The bottom surface 1k is formed with a insertion holes 11, 1m, 1n for inserting the pins for supporting the respective members when the power supply terminal 4, the bimetal 5, and the earth terminal 6a are molded with the metal mold.

The insertion hole 11 is a hole formed by inserting the metal mold pin (not shown) for supporting the power supply terminal 4 and the bimetal 5 at the time of molding, and has an effect to discharge heat from the plug 3 fitted in the socket 1. The insertion holes 1m, 1n are, as shown in FIG. 3, are holes formed by inserting the metal mold pins supporting the supporting strips 4d, 4e projected outwardly from the center of the power supply terminal 4 along the bottom surface 1k as shown in FIG. 3 at the time of molding, and has an effect to discharge heat of the plug 3 fitted to the socket 1.

The supporting strips 4d, 4e are formed with positioning holes 4f, 4g for receiving the tips of the metal mold pins to hold at the predetermined position. Since the power supply terminal 4 and bimetal 5 are supported by fitting a plurality of metal mold pins into the positioning holes 4f, 4g, 5c at the time of molding, it can be molded while being disposed at the precise position by insert molding.

The bottom surface 1k is, as shown in FIGS. 1, 3, 6, and 7, formed with a plurality of projections 1o projecting outwardly of the opening 1a for preventing short circuit. The projection 1o is a projection for preventing short circuit in case where an infant or the like inserts the conductive member such as a coin into the socket 1, and the conductive member is brought into contact with the power supply terminal 4.

As shown in FIG. 1, the power supply terminal 4 projects from the back surface of the socket 1 to be electrically connected to the battery via the mating connector (not shown) at one end, and is provided with a connecting projection 4a exposed inwardly at the center of the bottom portion 1k of the socket 1 at the other end, so that the connecting projection 4a is brought into contact with the electrode 3a urged by the spring 3b to establish electric connection. The connecting projection 4a is a projection having a shoulder 4b, and the connecting projection 4a is fitted into the through hole 5a of the bimetal 5, and the peripheral region of the through hole 5a is welded to the shoulder 4b by resistance welding or the like.

The fixing means between the power supply terminal 4 and the bimetal 5 is not specifically limited as far as they are always connected electrically. For example, the bimetal 5 may be fixed to the power supply terminal 4 by caulking.

The bimetal 5 is formed of a plate member in the shape of near L-shape as show in FIG. 1, the fixed side of which at one end is fixed to the shoulder potion 4b by means of measures such as caulking or the like and the temperature deformation side 5b at the other end is disposed in the hollow portion 1j of the bottom surface 1k of the socket 1. At normal temperature, the temperature deformation portion 5b is not in contact with the inner case 6 provided on the inner side of the socket 1 as shown by a solid line in FIG. 1, and when it is heated to a high temperature by abnormal heat generation or the like, it incurvates as shown by a phantom line in FIG. 1 to come into contact with the inner case 6. The bimetal 5 is a safety apparatus that constructs the short circuit mechanism that short-circuits when it comes into contact with the inner case 6, and prevents the car blaze or the like by melting the fuse mounted on the side of the harness (not shown) of the vehicle body.

In the hollow portion 1j described above, a temperature deformation portion 5b of the bimetal 5 is disposed so as to be capable of incurvated deformation as shown in FIG. 1, and when the bimetal 5 is molded in the socket 1 by insert molding, the pin (not shown) is inserted into the hollow portion 1j to the extent that the tip of the pin is fitted into the positioning hole 5c for molding. The positioning hole 5c is disposed at the end of the opening of the hollow portion 1j.

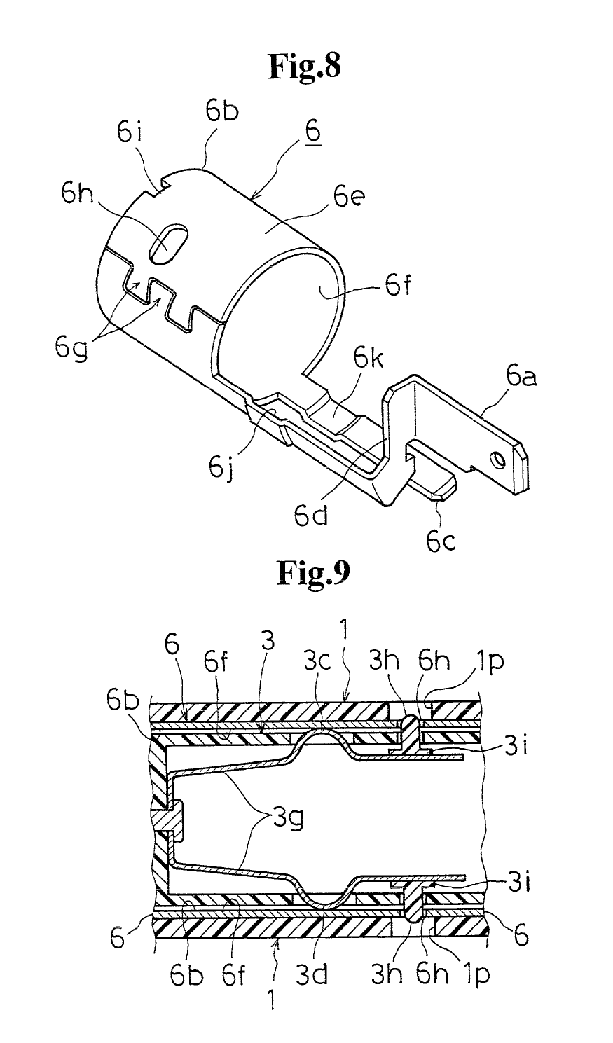

The inner case 6 comprises, as shown in FIG. 1, FIG. 3, FIG. 6, and FIG. 8, a cylindrical portion 6b to be brought into contact with a resilient electrode strips 3c, 3d, a terminal 6c extending from the cylindrical portion 6b, an earth terminal 6a, and a distribution board portion 6d formed between the earth terminal 6a and the cylindrical portion 6b formed as a single piece.

The inner case 6 is formed by press-molding the conductive metal plate formed of copper alloy or the like, and fixed to the socket 1 by insert molding. The end portion 6e of the inner case 6 on the side of the opening 1a is formed at the position inner than the opening 1a to prevent physical contact therewith as shown in FIG. 3. The inner wall surface 6f of the cylindrical portion 6b of the inner case 6 is flush with the inner wall surface 1t of the socket 1 as shown in FIG. 1 and FIG. 3.

The cylindrical portion 6b is a portion that is disposed inside near the opening 1a for coming into contact with the resilient electrodes 3c, 3d of the plug 3 for grounding as shown in FIG. 1 and FIG. 3. The cylindrical portion 6b is, as shown in FIG. 8, formed by engaging the trapezoidal engaging portions 6g formed along both edges of a near square plate with respect to each other into a cylindrical shape. The cylindrical portion 6b is, as shown in FIG. 2, formed with a plug holding portion 6h, which is a hole formed at the same position as the inserting space 1p of the socket 1. At the end of the opening of the cylindrical portion 6b, as shown in FIG. 8, there is formed a notched portion 6i for holding the inner case 6 to be inserted therein by engaging the metal mold pin when the socket 1 is molded with a resin.

From the cylindrical portion 6b, the earth terminal 6a and the terminal 6c are formed as a single unit so as to project therefrom. The earth terminal 6a and the terminal 6c are formed with bent recesses 6j, 6k for preventing short-circuit by burying the earth terminal 6a and the terminal 6c with an insulating resin material B forming the socket 1 so that the coin A does not come into contact with the power supply terminal 4 and the inner case 6 simultaneously when a conductive body such as a coin A or the like is inserted into the socket 1 by mistake as shown in FIG. 1.

The recesses 6j, 6k are formed at the positions in such a manner that when the end of the coin A or the like inserted into the socket 1 comes into contact with the power supply terminal 4, the other end of the coin A or the like comes into contact with the inner wall surface 1t, and a resinous material B forming the socket 1 is poured into the recesses 6j, 6k to prevent it from being exposed. This can prevent short-circuit because the coin A is never be brought into contact with the power supply terminal 4 and the inner case 6 simultaneously to constitute a part of the electrical circuit.

The position to form the recesses 6j, 6k on the inner case 6 is not limited to the position shown in FIG. 1 and FIG. 8, but it must simply be between the cylindrical portion 6b and the earth terminal 6a, or the portion between the cylindrical portion 6b and the earth terminal 6a may be buried within the socket 1 with a resinous material.

The terminal 6c is formed of a plate extending from the cylindrical portion 6b along the inner wall surface 1t of the socket 1 to the back surface of the bottom surface 1k. In case of abnormal heat generation, the bimetal 5 is deformed and comes in contact with the terminal 6c. The terminal 6c may be formed integrally with the earth terminal 6a projected from the cylindrical portion 6b, and the earth terminal 6a may be constructed to serve also as the terminal 6c by allowing the bimetal 5 to come into contact with a part of the earth terminal 6a.

The earth terminal 6a is a terminal that projects from the portion in the vicinity of the power supply terminal 4 on the back surface of the bottom of the socket 1 to be fitted to the mating connector. The distribution board 6d is a member that is formed between the earth terminal 6a and the recess 6j to connect them with each other, and is buried in the bottom surface 1k of the socket 1 as shown by a phantom line in FIG. 6. The bottom surface 1k is, as shown in FIG. 5, FIG. 6, and FIG. 7, formed with a hollow portion 1j and insertion holes 1l, 1m, 1n, in the shape like four beams. The distribution board 6d may simply be inserted into any one of four beams and molded by insertion molding.

The plug 3 to be fitted into the opening 1a of the socket 1 is a electrically connecting equipment for connecting various charger for mobile telephones, or the electrical appliances such as the TV set or the navigator apparatus and the like to be retrofitted with the socket of the cigarette lighter.

The present invention is constructed as described thus far, and the manufacturing procedure and the operation will be described in detail below.

In a first place, the electrode terminal 4, the bimetal 5, and the metallic member for the inner case are press-molded. The electrode terminal 4 and the bimetal 5 are fixed by welding or caulking. Then, the respective metal mold pins are fitted into the positioning holes 4f, 4g of the power supply terminal 4 and the positioning hole 5c for the bimetal 5 to set the metal mold, and a resinous material is poured into the metal mold to mold the socket 1 with a metal mold. In this way, the socket 1 needs only the small number of components, processes, and assembling man-hour, and thus is low in cost and suitable for mass production.

The projecting strip 7c of the lid 7 is pushed into the hinge portion 1c of the socket 1 to mount the lid 7 to the socket 1.

By pushing the socket 1 into the mounting hole 2a of the vehicle-side member 2, the resilient arresting strips 1e, 1f is press-fitted into the inner edge of the installing hole 2a as shown in FIG. 1 so that the socket 1 can be mounted to the vehicle body member 2 through one-touch operation. By fitting the mating connector to the power supply terminal 4 and the earth terminal 6a, the assembly to the vehicle body member 2 is completed.

When the thickness of the vehicle-side member 2 to which the socket 1 is mounted is large, the socket 1 can be mounted to the vehicle-side member 2 by engaging the nut 8 with the threaded portion 1i as shown in FIG. 3. Therefore, it can be mounted at various portion of the vehicle-side member 2.

Since the present invention is constructed and operated as describe so far, the following advantages are achieved.

Since the invention according to the first aspect is a socket for automotive vehicles for receiving the plug of the appliance for automotive vehicles to electrically connect to the power supply, comprising a near cylindrical resinous molded body having a flange formed along the outer periphery of the opening to which the plug is inserted, and a terminal formed on the bottom surface by insert molding, the entire socket can be formed with a resin at a time, and thus the number of components and of the step of assembling operation can be reduced to reduce the cost. In addition, since the bottom surface of the socket does not need the rivet for fixing the terminal that has been conventionally used, or the insulator for insulation, the construction of the socket may be simplified.

Since the invention according to the second aspect is an invention according to the first aspect, wherein a conductive inner case to be brought into contact with a resilient electrode of the plug is provided on the inner wall surface of the socket, and a bimetal to be brought into contact with the terminal in conduction with the inner case in case of abnormal heat generation is electrically connected to the terminal disposed on the bottom surface thereof, occurrence of the accident such as fire due to abnormal heat generation can be prevented with a simplified construction without increasing the number of the components.

Since the invention according to the third aspect is an invention according to the second aspect, wherein the inner case comprises a cylindrical portion formed on the inner wall surface of the socket, the terminal projected from the cylindrical portion, and the earth terminal all formed of a piece of conductive metal plate, the cylindrical portion, the terminal, and the earth terminal can be formed with a member, and thus the number of components and of assembling man-hour can be reduced to reduce the cost.

Since the invention according to the fourth aspect is an invention according to the third aspect, wherein the terminal and the earth terminal are formed by tucking down from the inner surface of the socket to form a recess for disposing the resin material forming the socket, the short-circuit that may be occurred when a conductive body such as a coin is inserted into a socket by mistake may be prevented, and electric shock that may occur in the case of removing the coin may be prevented.

Since the invention according to the fifth aspect is an invention according to the second, third or fourth aspect, wherein the terminal comprises a power supply connecting portion projecting outwardly from the bottom surface of the socket and a connecting projection being in contact with the electrode portion of the plug and exposed from the center of the bottom surface, and wherein the bimetal is electrically connected to the terminal at the portion surrounding the connecting projection, the bimetal can be fixed to the terminal formed by combining the power supply connecting portion and the connecting projection as an unit without using a special fitting such as a rivet or the like, and thus the number of components and of assembling man-hour as well as the cost can be reduced.

Since the invention according to the sixth aspect is an invention according to the fifth aspect, wherein the terminal includes a supporting strip for positioning thereof projecting outwardly from the portion surrounding the connecting projection to be supported by the metal mold when the socket is molded by the metal mold, the socket can be formed while holding the terminal precisely and stably at the prescribed position without shaking when molding the terminal integrally with the socket, and thus the operation for molding the socket with the metal mold can easily be performed. Therefore, the terminal molded in the socket by insert molding and the bimetal can be disposed precisely and loose connection of the terminal and inferior operation of the bimetal can be prevented.

Since the invention according to the seventh aspect is an invention according to the sixth aspect, wherein the bottom surface of the socket is formed of a insertion hole adjacent to the supporting strip or the connecting projection, the terminal can be supported and thus the socket can be formed in precise dimensions and configuration by inserting the metal mold pin into the insertion hole when the socket is molded with the metal mold. In addition, since the bottom surface of the socket is formed with an insertion hole, the heat discharging effect that can discharge heat from the insertion hole can be achieved.

Since the invention according to the eighth aspect is an invention according to the fifth aspect, wherein the bimetal is formed into the shape of near L-shape and formed with a through hole for fitting the shoulder formed around the connecting projection therein on one end and provided with a temperature deformation portion inserted into the hollow portion formed on the bottom surface of the socket so as to be opposed to the terminal in conduction with the inner case on the other side, the bimetal can easily be installed around the connecting projection. By forming a hollow portion in the bottom surface, the heat discharge effect that can discharge heat from the hollow portion can be achieved, and water entered into the socket can discharged from the socket through the hollow portion, thereby providing waterproof function.

Since the invention according to the ninth aspect is an invention according to the first, second, third, fourth, fifth, sixth, seventh or eighth aspect, wherein the socket includes a projection formed of an insulating resin on the bottom surface, when an infant or the like inserted a conductive member such as a coin into the socket by mistake, the conductive member such as a coin comes into contact with the terminal to prevent short-circuit.

Since the invention according to the tenth aspect is an invention according to the first or second aspect, wherein the socket is formed with a resilient arresting strip on the outer periphery thereof to which the inner edge of the mounting hole on the vehicle-side member, and a threaded portion with which the nut for screwing the socket to the mounting hole on the vehicle-side member engages, the socket can be mounted to the mounting hole of different thickness of the vehicle body member, and thus the socket can conveniently be mounted at the position other than the limited prescribed position of the vehicle body member.

Since the invention according to the eleventh aspect is an invention according to the first, second, third, fourth or tenth aspect, wherein the socket is formed in the opening with a plug holding portion to which the resilient supporting portion provided on the outer periphery of the plug engages, the plug inserted into the socket is prevented from being fell off the socket due to vibration of vehicle-side member and thus the plug of smaller diameter than the prescribed size can be resiliently supported.

Since the invention according to the twelfth aspect is an invention according to the eleventh aspect, wherein the socket is provided with a mark on the flange for registering the resilient supporting portion of the plug and the plug holding portion, the mark serves as a registration when the resilient supporting portion of the plug is engaged with the plug holding portion of the socket, and thus the resilient supporting portion of the plug can easily be engaged with the plug holding portion of the socket.

What is claimed is:

1. A socket for automotive vehicles for receiving a plug of the appliance for automotive vehicles to electrically connect to a power supply, which comprising a near cylindrical resinous molded body having a flange formed along an outer periphery of an opening to which the plug is inserted, and terminals formed on the bottom surface by insert molding.

2. The socket for automotive vehicles as set forth in claim 1, wherein the socket is provided with a conductive inner case to be brought into contact with resilient electrodes of the plug on the inner wall surface of the socket, and a bimetal to be brought into contact with the terminal in conduction with the inner case in case of abnormal heat generation is electrically connected to the terminal disposed on the bottom surface thereof.

3. The socket for automotive vehicles as set forth in claim 2, wherein the inner case comprises a cylindrical portion formed on the inner wall surface of the socket, the terminal projected from the cylindrical portion, and the earth terminal all formed of a piece of conductive metal plate.

4. The socket for automotive vehicles as set forth in claim 3, wherein the terminal and the earth terminal are formed by tucking down from the inner wall surface of the socket to form recesses for disposing a resin material forming the socket.

5. The socket for automotive vehicles as set forth in claim 2, 3, or 4, wherein the terminal comprises a power supply connecting portion projecting outwardly from the bottom surface of the socket for being connected with the power supply, and a connecting projection being in contact with the electrode portion of the plug and exposed from the center of the bottom surface, and in that a bimetal is electrically connected to the terminal at the portion surrounding a connecting projection.

6. The socket for automotive vehicles as set forth in claim 5, wherein the terminal includes supporting strips for positioning thereof projecting outwardly from the portion surrounding the connecting projection to be supported by the metal mold when the socket is molded by the metal mold.

7. The socket for automotive vehicles as set forth in claim 6, wherein the bottom surface of the socket is formed of insertion holes adjacent to the supporting strips or the connecting projection.

8. The socket for automotive vehicles as set forth in claim 5, wherein the bimetal is formed into the shape of near L-shape and formed with a through hole for fitting a shoulder formed around the connecting projection therein on one end and provided with a temperature deformation portion inserted into a hollow portion formed on the bottom surface of the socket so as to be opposed to the terminal in conduction with the inner case on the other side.

9. The socket for automotive vehicles as set forth in claim 1, 2, 3, 4, 5, 6, 7 or 8, wherein the socket includes a projection formed of an insulating resin on the bottom surface.

10. The socket for automotive vehicles as set forth in claim 1 or 2, wherein the socket is formed with resilient arresting strips on the outer periphery thereof to which the inner edge of a mounting hole on a vehicle-side member abuts, and a threaded portion with which a nut for screwing the socket to the mounting hole on the vehicle-side member engages.

11. The socket for automotive vehicles as set forth in claim 1, 2, 3, 4 or 10, wherein the socket is formed in the opening with a plug holding portion to which resilient supporting portions provided on the outer periphery of the plug engages.

12. The socket for automotive vehicles as set forth in claim 11, wherein the socket is provided with a mark on the flange for registering the resilient supporting portions of the plug and the plug holding portion.
